(19) United States
(12) Patent Application Publication
(10) Pub. No.: US 2024/0100507 A1
(43) Pub. Date: Mar. 28, 2024

(54) COMPOSITION FOR INHIBITING NITRATE DECOMPOSITION AND ITS PREPARATION METHOD

(71) Applicant: Yangtze Delta Region Institute (Huzhou), University of Electronic Science and Technology of China, Huzhou (CN)

(72) Inventors: Yanjuan SUN, Huzhou (CN); Hong WANG, Huzhou (CN); Fan DONG, Huzhou (CN); Yangyang YU, Huzhou (CN); Bangwei DENG, Huzhou (CN); Si CHEN, Huzhou (CN); Qin GENG, Huzhou (CN)

(21) Appl. No.: 18/189,604

(22) Filed: Mar. 24, 2023

(30) Foreign Application Priority Data
Sep. 28, 2022 (CN) 202211220156.1

(51) Int. Cl. B01J 21/06; B01J 27/232; B01J 35/00

(52) U.S. Cl. CPC B01J 21/063; B01J 27/232; B01J 35/004

(57) ABSTRACT

Disclosed is a composition for inhibiting nitrate decomposition and its preparation method, which belongs to a field of photocatalytic technology, comprising: weighing titanium dioxide and pure phase metal carbonate or pure phase metal bicarbonate proportionally; adding the weighed pure phase metal carbonate or the pure phase metal bicarbonate to titanium dioxide for grinding to obtain a metal carbonate/bicarbonate-containing mixture. The method of inhibiting nitrate decomposition using the metal carbonate/bicarbonate of the present disclosure has a significant ability to inhibit nitrate decomposition, and the experimental results show that the method of inhibiting nitrate decomposition using the metal carbonate/bicarbonate can effectively inhibit the decomposition of the nitrate under irradiation for a long time. The method of inhibiting nitrate decomposition of the present disclosure is simple with obvious effect, which can realize the green application of titanium dioxide materials and avoid atmospheric environmental pollution.

### TECHNICAL FIELD

The present disclosure belongs to a field of photocatalytic technology, in particular relates to a composition for inhibiting nitrate decomposition and its preparation method.

### BACKGROUND ART

At present, the quality of the atmospheric environment is closely associated with human health and sustainable development. In recent years, fine particulate matter (PM_{2.5}) and ozone (O₃) have become the chief culprits leading to frequent fog and haze events, affecting the global climate and atmospheric oxidation. Nitrogen oxides (NOx) are important precursors for facilitating PM_{2.5} and O₃ formation. NOx concentration in the atmosphere has been reported to limit further reduction in PM_{2.5} concentration and promote an increase in O₃ concentration. It has been shown that nitrates accumulated on a surface of a material with photocatalytic properties can undergo photocatalytic decomposition under sunlight conditions, resulting in gas-phase decomposition product NOx. In recent years, various photocatalysts have been widely used due to their unique properties and excellent performance in various industries. Among them, titanium dioxide shows significant advantages.

It is an inevitable trend to make use of the characteristics of photocatalysts and perform their excellent functions in improving our lives. However, the photocatalytic surface of materials (such as self-cleaning glass, purification coatings, antifouling materials) that can be seen everywhere in life and atmospheric environment has taken a non-negligible role in causing nitrate decomposition and therefore causing atmospheric environmental pollution. However, there is still no effective means to control the photochemical decomposition process of nitrates adsorbed on the surface of these photocatalyst-containing materials. Therefore, the use of appropriate technical solutions to inhibit the decomposition of nitrates on its surface and avoid pollution to the atmospheric environment is an important new discovery to control atmospheric environmental pollution.

Based on the above analysis, the problems and defects of the prior art are: the nitrates accumulated on the surface of the existing titanium dioxide or other photocatalytic materials will be decomposed under irradiation and affect the catalytic performance and also cause atmospheric environmental pollution.

### SUMMARY

For the problems existing in the prior art, the present disclosure provides a method for inhibiting nitrate decomposition using a metal carbonate/bicarbonate.

The present disclosure is realized by a composition that inhibits nitrate decomposition, and in order to avoid affecting the photocatalytic performance of the photocatalyst and its physical and chemical properties, a metal salt and titanium dioxide can be uniformly mixed by a simple physical mixing method (such as, grinding, stirring) to obtain a mixture that can retain the original catalytic properties and can effectively inhibit nitrate decomposition.

Further, the metal salt may be a metal carbonate or a metal bicarbonate.

Further, the metal carbonate includes, but not limited to, sodium carbonate, calcium carbonate, barium carbonate, strontium carbonate, lanthanum carbonate, potassium carbonate.

Further, the metal bicarbonate includes, but not limited to, sodium bicarbonate, potassium bicarbonate.

Further, the method of inhibiting nitrate decomposition using a metal carbonate/bicarbonate includes the following steps of:
the first step of weighing titanium dioxide and a pure phase metal carbonate or a pure phase metal bicarbonate proportionally;
the second step of adding the pure phase metal carbonate or the pure phase metal bicarbonate to titanium dioxide, and using physical methods such as grinding to evenly distribute the metal carbonate or bicarbonate on the surface of titanium dioxide to obtain a mixture containing the metal carbonate/bicarbonate.

Further, the mass proportion of the metal carbonate/bicarbonate in titanium dioxide is greater than 1%.

Further, the mass proportion of the metal carbonate/bicarbonate in titanium dioxide may be 1%, 3%, 5%, 10%, 30%, or 50%.

Further, the grinding is physical grinding.

Another object of the present disclosure is to provide a mixture that can inhibit nitrate decomposition obtained based on the method of inhibiting nitrate decomposition using a metal carbonate/bicarbonate.

Another object of the present disclosure is to provide use of the mixture that can inhibit nitrate decomposition in the photocatalytic decomposition of a compound.

Combined with the technical problems to be solved and the above technical solutions, the advantages and positive effects of the claimed technical solutions by the present disclosure are:

The addition of a small amount of a metal carbonate/bicarbonate provided by the present disclosure can effectively inhibit nitrate decomposition, thereby greatly inhibiting the formation of gas phase decomposition products. The method is simple, and the metal carbonate/bicarbonate added can be selected from inexpensive and environmentally friendly ones; the content of the metal carbonate/bicarbonate added is adjustable, which, at low content, not only effectively inhibits the decomposition of a nitrate, but also avoids hindering the catalytic performance of the catalyst itself. In addition, the present disclosure not only has an efficient inhibiting effect on the decomposition of the nitrate on the surface of titanium dioxide, but also can be extended to inhibit the decomposition of the nitrate on the surface of similar compounds. After test under simulated sunlight irradiation condition for a long period of time, the mixture of the metal carbonate/bicarbonate and titanium dioxide provided by the present disclosure may have excellent stability for nitrate decomposition, which is beneficial to its application in the catalytic and environmental fields.

The present disclosure has a significant ability to inhibit nitrate decomposition, and the experimental results show that the present disclosure can inhibit nitrate decomposition for a long time under sunlight irradiation by using a metal carbonate/bicarbonate to inhibit nitrate decomposition. The method of inhibiting nitrate decomposition of the present disclosure is simple with obvious effect, which can realize the green application of titanium dioxide materials and avoid atmospheric environmental pollution.

The technical solution of the present disclosure fills the technical gap in the industry at home and abroad: at present, photocatalysts are widely used in many fields, and the catalytic decomposition releasing polluting gases that cause harm to the environment and human health have gradually attracted attention, but there is still no good solution to achieving green application of photocatalysts. The technical solution of the present disclosure just fills the gap in this aspect, can realize the green application of photocatalytic materials, and make great contributions to environmental protection.

In order to maintain the original photocatalytic properties of the photocatalytic materials, the present disclosure adopts a simple and easy-to-operate physical method to add a small amount of a metal carbonate/bicarbonate to achieve effective inhibition of nitrate decomposition. It overcomes the defects of complex operational processes, addition of a large amount of expensive or environmentally harmful materials, and the change in the original excellent properties of photocatalytic materials.

### BRIEF DESCRIPTION OF DRAWINGS

FIG. 1 is a flow chart of a method of inhibiting nitrate decomposition using a metal carbonate/bicarbonate provided in the examples of the present disclosure;

FIG. 2 is an XRD pattern of a mixture of calcium carbonate and titanium dioxide prepared in Examples 1, 2, 3, 4, 5, 10 provided in the examples of the present disclosure;

FIG. 3 is a profile of the concentration of gas phase products produced from nitrate decomposition on the surface of the mixture of the metal carbonate/bicarbonate and titanium dioxide prepared in Example 5 of the present disclosure varied with irradiation time;

FIG. 4 is a profile of the concentration of the gas phase products produced from nitrate decomposition on the surface of the mixture of the metal carbonate/bicarbonate and titanium dioxide prepared in Example 4 of the present disclosure varied with irradiation time;

FIG. 5 is a profile of the concentration of the gas phase products produced from nitrate decomposition on the surface of the mixture of the metal carbonate/bicarbonate and titanium dioxide prepared in Example 1 of the present disclosure varied with irradiation time;

FIG. 6 is a profile of the concentration of the gas phase products produced from nitrate decomposition on the surface of the mixture of the metal carbonate/bicarbonate and titanium dioxide prepared in Example 2 of the present disclosure varied with irradiation time;

FIG. 7 is a profile of the concentration of the gas phase products produced from nitrate decomposition on the surface of the mixture of the metal carbonate/bicarbonate and titanium dioxide prepared in Example 3 of the present disclosure varied with irradiation time;

FIG. 8 shows a comparison of the concentration of the gas phase products produced from nitrate decomposition on the surfaces of the mixtures of the metal carbonate/bicarbonate and titanium dioxide prepared in Examples 1, 2, 3, 4, 5 of the examples of the present disclosure;

FIG. 9 is a profile of the concentration of the gas phase products produced from the inhibiting decomposition of nitrate on the surface using the mixture of the metal carbonate/bicarbonate and titanium dioxide prepared in Example 10 of the present disclosure varied with irradiation time;

FIG. 10 shows comparison of the degradation efficiency of NO by using the mixtures of the metal carbonate/bicarbonate and titanium dioxide prepared in Examples 1, 2, 3, 10 of the present disclosure under irradiation;

FIG. 11 is a profile of the concentration of the gas phase products produced from nitrate decomposition on the surface of the mixture of the metal carbonate/bicarbonate and titanium dioxide prepared in Example 7 of the present disclosure varied with irradiation time;

FIG. 12 is a profile of the concentration of the gas phase products produced from nitrate decomposition on the surface of the mixture of the metal carbonate/bicarbonate and titanium dioxide prepared in Example 6 of the present disclosure varied with irradiation time;

FIG. 13 is a profile of the concentration of the gas phase products produced from nitrate decomposition on the surface of the mixture of the metal carbonate/bicarbonate and titanium dioxide prepared in Example 8 of the present disclosure varied with irradiation time;

FIG. 14 is a profile of the concentration of the gas phase products produced from nitrate decomposition on the surface of the mixture of the metal carbonate/bicarbonate and titanium dioxide prepared in Example 9 of the present disclosure varied with irradiation time;

FIG. 15 is a profile of the concentration of the gas phase products produced from nitrate decomposition on the surface of titanium dioxide provided in the examples of the present disclosure varied with irradiation time.

### DETAILED DESCRIPTION

In order to make the objectives, technical solution and advantages of the present disclosure clearer, the present disclosure will be further explained in detail with reference to the following embodiments. It should be understood that the specific embodiments described herein are only for explaining the present disclosure, but not for limiting the present disclosure.

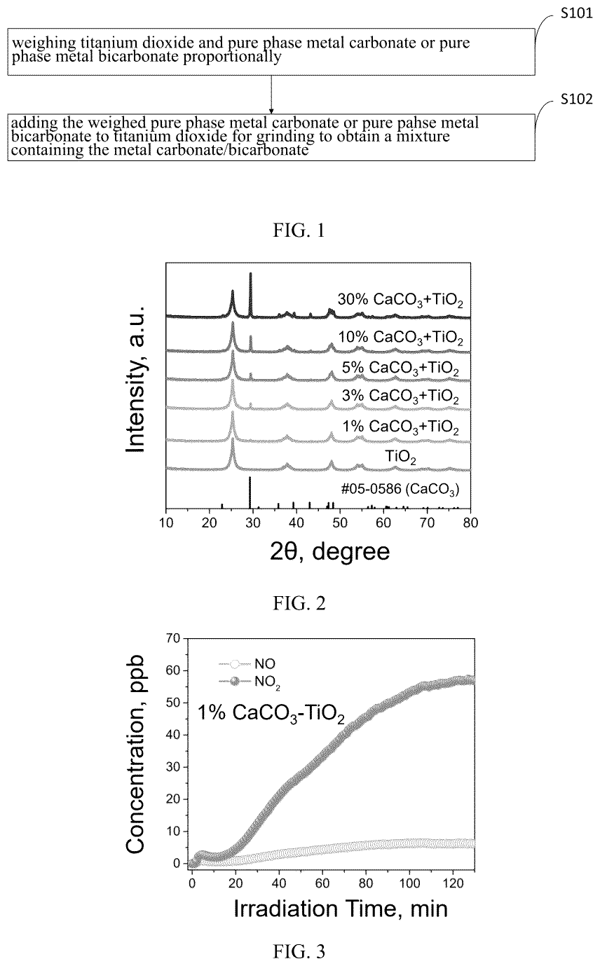

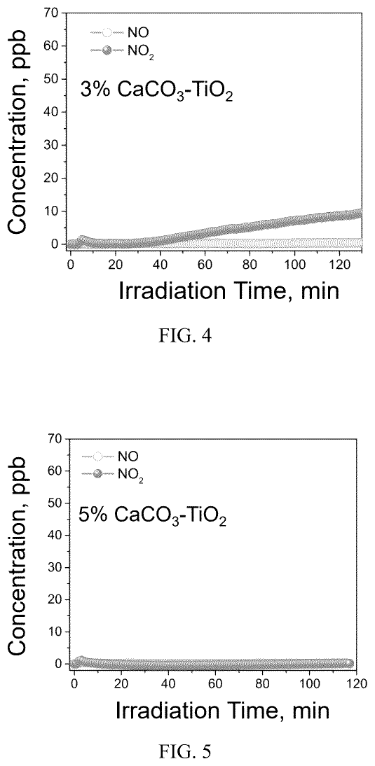

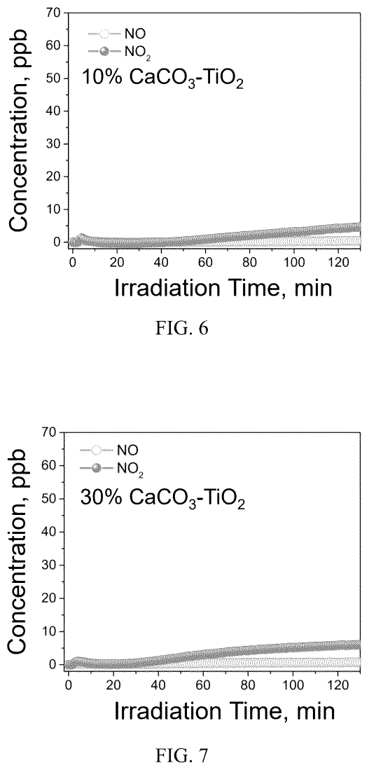

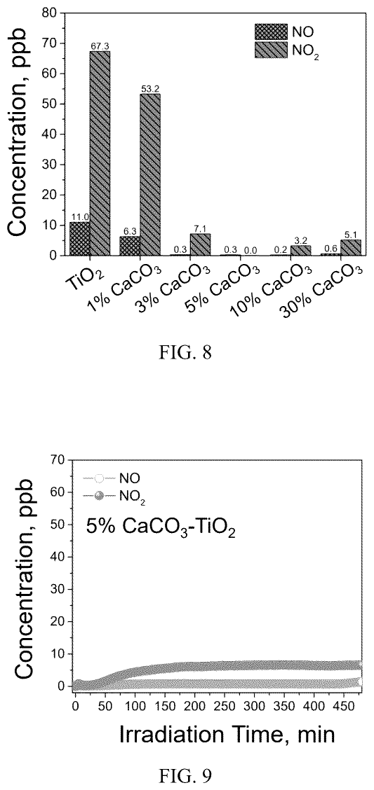

As shown in FIG. 1, the method of inhibiting nitrate decomposition using the metal carbonate/bicarbonate provided in the examples of the present disclosure comprises the following steps of:
S101, titanium dioxide and pure phase metal carbonate or pure phase metal bicarbonate were weighed proportionally;
S102, the weighed pure phase metal carbonate or the pure phase metal bicarbonate was added to titanium dioxide for physical grinding to obtain a metal carbonate/bicarbonate-containing mixture.

The mass of the metal carbonate/bicarbonate provided in the examples of the present disclosure accounted for more than 1% of the mass of titanium dioxide.

The metal carbonate/bicarbonate provided in the examples of the present disclosure may be sodium carbonate, calcium carbonate, barium carbonate, strontium carbonate, lanthanum carbonate, potassium carbonate, sodium bicarbonate, potassium bicarbonate, etc.

The technical solution of the present disclosure will be further explained in detail with reference to the following specific examples.

### Example 1

Calcium carbonate was weighed accounting for 5% of the mass of titanium dioxide, and then, it was poured into a mortar, and an evenly mixed mixture of calcium carbonate and titanium dioxide was obtained after physical stirring.

### Example 2

Calcium carbonate was weighed accounting for 10% of the mass of titanium dioxide, and then, it was poured into a mortar, and an evenly mixed mixture of calcium carbonate and titanium dioxide was obtained after physical stirring.

### Example 3

Calcium carbonate was weighed accounting for 30% of the mass of titanium dioxide, and then, it was poured into a mortar, and an evenly mixed mixture of calcium carbonate and titanium dioxide was obtained after physical stirring.

### Example 4

Calcium carbonate was weighed accounting for 3% of the mass of titanium dioxide, and then, it was poured into a mortar, and an evenly mixed mixture of calcium carbonate and titanium dioxide was obtained after physical stirring.

### Example 5

Calcium carbonate was weighed accounting for 1% of the mass of titanium dioxide, and then, it was poured into a mortar, and an evenly mixed mixture of calcium carbonate and titanium dioxide was obtained after physical stirring.

### Example 6

Strontium carbonate was weighed accounting for 5% of the mass of titanium dioxide, and then, it was poured into a mortar, and an evenly mixed mixture of strontium carbonate and titanium dioxide was obtained after physical stirring.

### Example 7

Barium carbonate was weighed accounting for 5% of mass of titanium dioxide, and then, it was poured into a mortar, and an evenly mixed mixture of barium carbonate and titanium dioxide was obtained after physical stirring.

### Example 8

Sodium carbonate was weighed accounting for 5% of mass of titanium dioxide, and then, it was poured into a mortar, and an evenly mixed mixture of sodium carbonate and titanium dioxide was obtained after physical stirring.

### Example 9

Sodium bicarbonate was weighed accounting for 5% of mass of titanium dioxide, and then, it was poured into a mortar, and an evenly mixed mixture of sodium bicarbonate and titanium dioxide was obtained after physical stirring.

### Example 10

Calcium bicarbonate was weighed accounting for 5% of the mass of titanium dioxide, and then, it was poured into a mortar, and an evenly mixed mixture of calcium carbonate and titanium dioxide was obtained after physical stirring.

The examples of the present disclosure have achieved some positive effects in the process of research and development or use, and do have great advantages compared with the prior art, the following content is described in combination with the data of the test process and drawings.

1. Characterization Experiment

XRD analysis of the mixture of calcium carbonate and titanium dioxide (shown in FIG. 2) confirmed the presence of both calcium carbonate and titanium dioxide phases in the mixture.

The titanium dioxide mixtures containing 5% of calcium carbonate, 10% of calcium carbonate, 30% of calcium carbonate, 3% of calcium carbonate, 1% of calcium carbonate, 5% of strontium carbonate, 5% of barium carbonate, 5% of sodium carbonate, 5% of sodium bicarbonate, or 5% calcium bicarbonate, respectively, prepared in Examples 1-10 of the present disclosure were subjected to XRD characterization.

2. Test of Nitrate Decomposition:
The metal carbonate/bicarbonate provided in the examples of the present disclosure not only can inhibit the decomposition of a nitrate by titanium dioxide, but also can be applied to iron oxide, the composite of titanium dioxide and aluminum oxide, bimetallic hydroxides and other compounds with the same mechanism for nitrate decomposition as titanium dioxide, and therefore, the use of titanium dioxide in the examples of the present disclosure to test nitrate decomposition is representative.

2.1 Experimental Process of Decomposition

The prepared mixtures of the metal carbonate/bicarbonate and titanium dioxide of the present disclosure were tested on nitrate decomposition. The specific process was as follows:
(1) 0.2 g of the mixture of the metal carbonate/bicarbonate and titanium dioxide prepared by the example and a nitrate solution were evenly mixed and placed in a glass disc for drying;
(2) four small fans were installed around the reactor to eliminate the influence of temperature on the reaction;
(3) under a dark condition, when the NOx concentration was close to zero and reached equilibrium, the mixture of the metal carbonate/bicarbonate and titanium dioxide was irradiated with a 150 W tungsten halogen lamp for about 130 min, and then the lamp was turned off.

The conditions of the test process of nitrate decomposition product were: a relative humidity of 60%; an oxygen content of 21%; an air flow of 1.5 L/min.

2.2 Decomposition Experiment of Examples

The titanium dioxide mixtures containing 5% of calcium carbonate, 10% of calcium carbonate, 30% of calcium carbonate, 3% of calcium carbonate, 1% of calcium carbonate, 5% of strontium carbonate, 5% of barium carbonate, 5% of sodium carbonate, or 5% of sodium bicarbonate, respectively, prepared in Examples 1-9 of the present disclosure were tested for nitrate decomposition:

The specific process was as follows: under the condition of a relative humidity of 60%, an oxygen content of 21%, and an air flow of 1.5 L/min, 0.2 g of titanium dioxide mixture containing 5% of calcium carbonate prepared in the example was added to the nitrate solution and placed on a glass disc, and was evenly mixed and dried for use; four small fans were installed around the reactor; under the dark condition, when the NOx concentration was reduced to the minimum and reached equilibrium, titanium dioxide loaded with the nitrate, which contains 5% of calcium carbonate was irradiated with a 150 W tungsten halogen lamp for 130 min and the lamp was turned off.

The test on nitrate decomposition was performed for titanium dioxide mixture containing 5% of calcium bicarbonate prepared in Example 10 of the present disclosure:

The specific process was as follows: under the condition of a relative humidity of 60%, an oxygen content of 21%, and an air flow of 1.5 L/min, 0.2 g of titanium dioxide mixture containing 5% of calcium carbonate prepared in the example was added to the nitrate solution and placed on a glass disc, and was evenly mixed and dried for use; four small fans were installed around the reactor; under the dark condition, when the NOx concentration was reduced to the minimum and reached equilibrium, titanium dioxide loaded with nitrate, which contains 5% of calcium carbonate was irradiated with a 150 W tungsten halogen lamp for 610 min and the lamp was turned off.

3. Test on Catalytic Performance:

The prepared mixtures of the metal carbonate/bicarbonate and titanium dioxide of the present disclosure were tested on catalytic performance. The specific process was as follows:
(1) 0.2 g of the mixture of the metal carbonate/bicarbonate and titanium dioxide prepared in the example was placed on a glass disc;
(2) four small fans were installed around the reactor to eliminate the influence of temperature on the reaction;
(3) under the dark condition, when the NOx concentration reached equilibrium, the mixture of the metal carbonate/bicarbonate mixture and titanium dioxide was irradiated with a 150 W tungsten halogen lamp for about 120 min and then the lamp was turned off.

The conditions of the above test process of catalytic performance are: a relative humidity of 60%; an oxygen content of 21%; a total air flow of NO and air of 1.5 L/min; an initial concentration of NO of 600 μg/kg.

4. NO Degradation Experiment:

The degradation effect of NO by the mixtures of the metal carbonate/bicarbonate and titanium dioxide provided in the examples of the present disclosure were as follows:

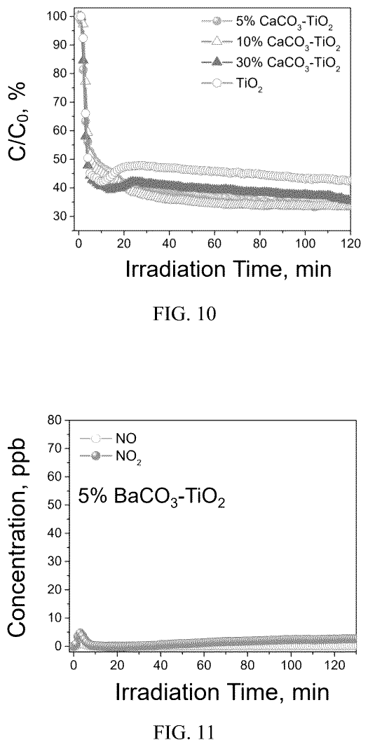

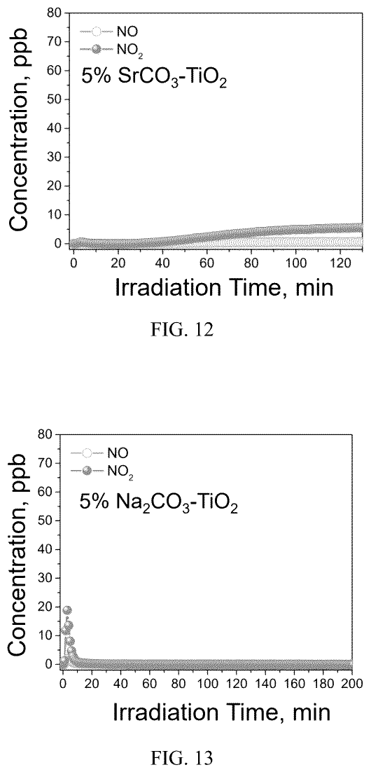

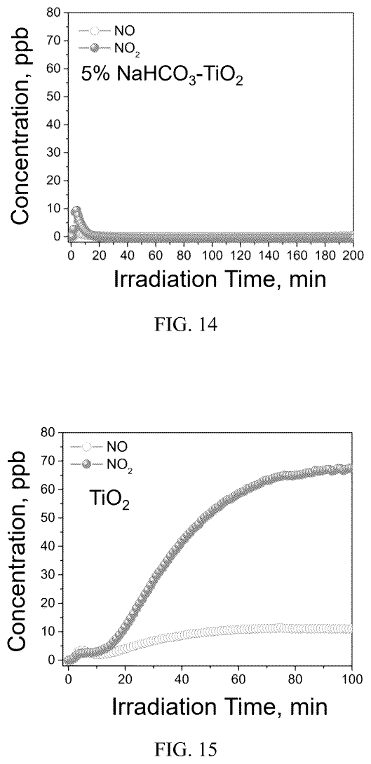

(1) the degradation rate of NO by the mixture of the metal carbonate/bicarbonate and titanium dioxide was about 63.0% (as shown in FIG. 10), which was similar to the degradation rate of NO by titanium dioxide, and the degradation rate was calculated as η (%)=(1−C/C₀)×100%, wherein C₀ was the initial NO concentration, and C was the instant concentration of NO after 120 minutes of irradiation.

5. Experimental Results:

5.1 Test Results of Nitrate Decomposition

The test on the nitrate decomposition by titanium dioxide revealed that the concentration of gas phase products produced from the nitrate decomposition by the titanium dioxide under irradiation could reach about 80 ppb.

5.2 Comparison Experimental Results of Examples

The concentration of the gas phase product produced from the nitrate decomposition by titanium dioxide containing 5% of calcium carbonate prepared in Example 1 was reduced to about 5 ppb, and the addition of a small amount of calcium carbonate can effectively inhibit the gas phase product produced from the photocatalytic nitrate decomposition on the surface of titanium dioxide.

The concentration of the gas phase products produced from the nitrate decomposition by titanium dioxide mixture containing 10% of calcium carbonate prepared in Example 2 was reduced to about 5 ppb.

The concentration of the gas phase products produced from the nitrate decomposition by titanium dioxide mixture containing 30% of calcium carbonate prepared in Example 3 was reduced to about 7 ppb.

The concentration of the gas phase products produced from the nitrate decomposition by titanium dioxide mixture containing 3% of calcium carbonate prepared in Example 4 was reduced to about 10 ppb.

The concentration of the gas phase products produced from the nitrate decomposition by titanium dioxide mixture containing 1% of calcium carbonate prepared in Example 5 was reduced to about 64 ppb.

The concentration of the gas phase products produced from the nitrate decomposition by titanium dioxide mixture containing 5% of strontium carbonate prepared in Example 6 was reduced to about 7 ppb.

The concentration of the gas phase products produced from the nitrate decomposition by titanium dioxide mixture containing 5% of barium carbonate prepared in Example 7 was reduced to about 4 ppb.

The concentration of the gas phase products produced from the nitrate decomposition by titanium dioxide mixture containing 5% of sodium carbonate prepared in Example 8 was reduced to about 1 ppb.

The concentration of the gas phase products produced from the nitrate decomposition by titanium dioxide mixture containing 5% of sodium bicarbonate prepared in Example 9 was reduced to about 1 ppb.

The concentration of the gas phase products produced from the nitrate decomposition by titanium dioxide mixture containing 5% of calcium bicarbonate prepared in Example 10 was reduced to about 8 ppb.

Table 1. Test results of the concentration of the gas phase products from the nitrate decomposition by the mixtures of the metal carbonate/bicarbonate and titanium dioxide prepared in the examples and the comparative examples of the present disclosure under irradiation for 100 minutes.

| Examples | 1 | 2 | 3 | 4 | 5 | 6 | 7 | 8 | 9 | 10 |
|---|---|---|---|---|---|---|---|---|---|---|
| The | 4.9 | 3.4 | 5.7 | 7.4 | 59.5 | 5.4 | 2.6 | 0.5 | 0.3 | 7.1 |
| concentration | | | | | | | | | | |
| of NOx (ppb) | | | | | | | | | | |

It can be seen from Table 1 that the metal carbonate/bicarbonate had an excellent inhibiting effect on the decomposition of the nitrate on the surface of titanium dioxide, and the decomposition product concentration was significantly reduced. Moreover, the method of inhibiting nitrate decomposition by the metal carbonate/bicarbonate is simple and stable, which is conducive to its promotion in practical applications.

In the method provided by the examples of the present disclosure, there may be various kinds of compounds to achieve the decomposition of nitrate under irradiation, kinds of which are not limited by the present disclosure. A common compound with an ability to photocatalyze nitrate decomposition is titanium dioxide.

After analyzing the experiments, it can be seen that the mixture of the metal carbonate/bicarbonate and titanium dioxide prepared by the method of the present disclosure can greatly inhibit the nitrate decomposition product on its surface, and the NOx concentration produced can be reduced to 0.3 ppb, and the method of inhibiting nitrate decomposition is simple, which is conducive to practical application.

The above merely describes the specific embodiments of the present disclosure, which is not intended to limit scope of protection of the present disclosure. Any modifications, equivalent substitutions and improvements made within the spirit and the principle of the present disclosure should be included in the protection scope of the present disclosure.

1. A composition for inhibiting nitrate decomposition, wherein the composition comprises a mixture of a metal carbonate/bicarbonate and titanium dioxide.

2. The composition for inhibiting nitrate decomposition according to claim 1, wherein the metal salt is a metal carbonate or a metal bicarbonate.

3. The composition for inhibiting nitrate decomposition according to claim 2, wherein the metal carbonate comprises one of sodium carbonate, calcium carbonate, barium carbonate, strontium carbonate, lanthanum carbonate, potassium carbonate.

4. The composition for inhibiting nitrate decomposition according to claim 2, wherein the metal bicarbonate comprises one of sodium bicarbonate, potassium bicarbonate.

5. A method of preparing the composition as claimed in claim 1, wherein the method comprises the following steps of:
the first step of weighing titanium dioxide and pure phase metal carbonate or pure phase metal bicarbonate proportionally;
the second step of adding the weighed pure phase metal carbonate or pure phase metal bicarbonate to titanium dioxide for grinding to obtain a mixture containing the metal carbonate/bicarbonate.

6. The method of preparing the composition as claimed in claim 5, wherein a mass of the metal carbonate/bicarbonate accounts for more than 3% of a mass of titanium dioxide.

7. The method of preparing the composition according to claim 5, wherein a mass proportion of the metal carbonate/bicarbonate in titanium dioxide is 1%, 3%, 5%, 10%, 30%, or 50%.

8. The method of preparing the composition as claimed in claim 5, wherein the grinding is physical grinding.

9. A mixture for inhibiting nitrate decomposition prepared by a method of preparing a composition as claimed in claim 5.

10. Use of a mixture as claimed in claim 9 in photocatalytic decomposition of a compound.
